(19) United States
(12) Patent Application Publication
(10) Pub. No.: US 2021/0339850 A1
(43) Pub. Date: Nov. 4, 2021

(54) A PROPULSION SYSTEM FOR A MULTIROTOR AIRCRAFT

(71) Applicant: AEROSPACE HOLDINGS INC., Cheyenne, WY (US)

(72) Inventors: Alexandru Predonu, Ilfov Voluntari (RO); Dacian Ioan Vinereanu, UNIRII Bd. Bucharest (RO)

(73) Assignee: AEROSPACE HOLDINGS INC., Cheyenne, WY (US)

(21) Appl. No.: 17/259,727

(22) PCT Filed: Jul. 13, 2018
(86) PCT No.: PCT/EP2018/069177

§ 371 Date: Jan. 12, 2021

(51) Int. Cl. B64C 27/10; B64D 27/24

(52) U.S. Cl. CPC B64C 27/10; B64D 2027/026; B64D 27/24

(57) ABSTRACT

A propulsion system for a multirotor aircraft, the propulsion system comprising: at least one power generation module configured to provide a first source of electrical power to one or more propulsion assemblies of the multirotor aircraft; a control system which is configured to determine the required electrical power demand of the propulsion assembly and calculate a predicted electrical power demand for a following period of time; wherein the control system is configured to alter the electrical power produced by the power generation module such as to produce a power envelope which comprises the electrical power produced by the power generation module corresponding to the predicted electrical power demand; wherein the control system is configured to determine if the power envelope meets the required electrical power demand; and wherein when the power envelope is less than the required electrical power demand the control system is configured to selectively connect a second source of electrical power for supplying power to the propulsion assembly such as to compensate for the difference between the power envelope and the required electrical power demand.

### FIELD OF THE INVENTION

This invention relates to a propulsion system for a multirotor aircraft and in particular a propulsion system for a multirotor aircraft which comprises a hybrid propulsion system.

### BACKGROUND TO THE INVENTION

Multirotor aircraft (or rotary-wing aircraft) are aircraft which use more than two rotors for propulsion, their main flight characteristic being the ability of vertical takeoff and landing. Unlike traditional rotary-wing aircraft (such as the helicopter), multirotor aircraft are equipped with a distributed electrical propulsion (DEP) system which consists of several motors which are mechanically linked to the propellers, as well as an electronic system which controls stability by varying the speed of the propellers, and an energy source (electrical or chemical).

The advantages of multirotor aircraft, when compared to traditional rotary-wing aircraft, consist of the absence of transmission mechanisms for both the main and the tail rotors (reducer gears, transmission axles, mechanical couplings) and the lack of complex mechanical systems for controlling the cyclic variable pitch. One of the major advantages is the increased redundancy, as multirotor aircraft can maintain a stable flight in case one or more propeller units (motor-propeller) malfunction, depending on the configuration and number of rotors employed.

Electric propulsion systems for fixed-wing or multirotor aircraft are known, which consist of an assembly/assemblies of motor-propeller propulsion systems, using electrical accumulators as an energy source. The disadvantage of these systems is the reduced quantity of electrical energy which can be stored in accumulators, and the significant weight of the accumulators, which generate a reduced flight time (typically under 30 min), as well as a reduced payload capacity, making this type of electric aircraft impractical for commercial use. It is a known that the energy density of the latest electrical accumulators does not currently exceed 180-200 Wh/Kg (gasoline, for example, has 12.8 kWh/Kg), thereby significantly limiting their use as an exclusive energy source for aircraft. An example of such a multirotor aircraft is the volocopter.

Hybrid electric propulsion systems have been applied in the automotive industry for example, the Lotus range extender, but these are efficient only in the auto industry, as they currently stand. These systems, referred to as series-hybrid, involve sets of very large and heavy accumulators which would not be of practical use in aircraft.

It is known that a motor—generator unit cannot supply a significant surplus of energy within a very short time frame (for example a tenth of a second), because of the long acceleration time of an internal combustion engine, as well as its significant inertia. Furthermore, the continuous variation in the power which is generated by a motor—generator unit leads to a very inefficient operation.

It is also known that the use of internal combustion motor—propeller assemblies for generating thrust in multirotor aircraft is not practically feasible because of the major difficulties in controlling the aerodynamic thrust generated by these assemblies in real-time.

An objective of the invention is to increase the performance, operational safety and reliability of multirotor aircraft by creating an electric propulsion system which would remove the disadvantages mentioned earlier, ensuring a sufficient flight time in accordance with the aviation requirements regarding minimum flight time, effectively making multirotor aircraft a viable solution. The increased reliability of the aircraft will be achieved through the use of a redundant energy source, whereby any malfunction of the motor-generator units or peripheral equipment will be countered by connecting the electrical accumulators assembly to the system.

Another objective of the invention is to increase the performance of the system and to lower the fuel consumption by creating a method of controlling the electric propulsion system, which will ensure the prediction of the electrical power demand (the required power envelope) for the current flight conditions or different operational points.

### SUMMARY OF THE INVENTION

Accordingly a first aspect of the invention provides a propulsion system for a multirotor aircraft, the propulsion system comprising: at least one power generation module configured to provide a first source of electrical power to one or more propulsion assemblies of the multirotor aircraft; a control system which is configured to determine the required electrical power demand of the propulsion assembly and calculate a predicted electrical power demand for a following period of time; wherein the control system is configured to alter the electrical power produced by the power generation module such as to produce a power envelope which comprises the electrical power produced by the power generation module corresponding to the predicted electrical power demand; wherein the control system is configured to determine if the power envelope meets the required electrical power demand; and wherein when the power envelope is less than the required electrical power demand the control system is configured to selectively connect a second source of electrical power for supplying power to the propulsion assembly such as to compensate for the difference between the power envelope and the required electrical power demand.

Preferably, wherein when the power envelope exceeds the required electrical power demand the control system is configured to selectively connect an electrical load assembly such as to compensate for the difference between the power envelope and the required electrical power demand.

Ideally, the propulsion system comprises at least two power generation modules.

Preferably, the power generation module(s) comprise an internal combustion engine and an electric generator, wherein the internal combustion engine is configured to drive the electrical generator.

Ideally, the electrical load assembly comprises one or more auxiliary components such as air conditioning systems, heating systems, lights, display devices, computing devices or any other suitable device.

Optionally, the electrical load assembly comprises passive loads such as an electrical resistor.

Ideally, the second source of electrical power comprises one or more electrical accumulators such as a battery.

Preferably, the propulsion assembly comprises an electric motor coupled to a propeller.

Ideally, the propulsion system further comprises a plurality of propulsion assemblies.

Preferably, the control system comprises a flight controller which is configured to monitor and/or control the operation of the propulsion assemblies, wherein the flight controller is configured to determine the electrical energy required by the propulsion assemblies to achieve a specific thrust.

Ideally, the flight controller is configured to determine the electrical energy required by the propulsion assemblies to achieve a specific thrust using measurements of one or more environmental conditions obtained by the flight controller.

Preferably, the flight controller comprises one or more sensors configured to measure the environmental conditions.

Ideally, the control system further comprises a power prediction system which is configured to determine the predicted electrical power demand.

Preferably, the power prediction system is coupled to the flight controller and is configured to determine the predicted electrical power demand using one or more measurements obtained therefrom.

Ideally, wherein the one or more measurements comprise at least one of: the required electrical energy in the last “n” time samples; stage and type of current flight; environment data; data regarding wind intensity and direction; atmospheric turbulence intensity; flight configuration; and/or predictable flight commands according to flight plan.

Preferably, the control system comprises an engine controller which is configured to monitor and/or control the operation of the internal combustion engine, wherein the engine controller is configured to control one or more operating conditions of the combustion engine.

Ideally, the control system comprises a generator controller configured to, convert the AC current produced by the electrical generator into DC, and/or control the operation of the electrical generator, wherein the generator controller is configured to control one or more operating conditions of the electrical generator.

Preferably, the control system comprises an electrical controller for monitoring and/or controlling the operation of the electrical accumulator.

Ideally, the control system comprises a load control unit configured to selectively connect the one or more electrical loads.

Preferably, the control system comprises a central processing unit to which the flight controller and/or power predication system and/or engine controller and/or generator controller and/or load control unit are coupled to and configured to receive instructions therefrom.

A multirotor aircraft comprising the propulsion system as recited in the first aspect of the invention.

A second aspect of the invention provides a method for controlling a propulsion system for a multirotor aircraft, the method comprising:
Determining a required electrical power demand for the propulsion system corresponding to the electrical power required to provide propulsion to the aircraft;
Calculating a predicted electrical power demand for a set period of time;
Altering the electrical power produced by the propulsion system such as to produce a power envelope which corresponds to the predicted electrical power demand;
Determining if the power envelope is sufficient to meet the required electrical power demand;
Wherein if the power envelope is not sufficient, the method further comprising connecting an additional source of electrical power for compensating for the difference between the power envelope and the required electrical power demand.

Ideally, if the power envelope is sufficient, the method further comprising connecting an electrical load assembly.

Preferably, repeating the method steps embodying the second aspect of the invention at pre-set time intervals.

Ideally, wherein calculating the predicted electrical power demand comprises one or more of the following steps:
Measuring the required electrical energy demand in the last “n” time samples;
Measuring one or more characteristics of the current flight;
Measuring environment data of the environment in which the aircraft is located;
Measuring one or more flight configurations; and
Calculating a predicted electrical power demand using one or more of the measurements obtained at any one of the previous steps.

A computer-readable medium comprising non-transitory instructions which, when executed, cause a processor to carry out a method according to the second aspect of the invention.

### BRIEF DESCRIPTION OF THE DRAWINGS

Embodiments of the invention are now described by way of example with reference to the accompanying drawings in which:

FIG. 1 is a side sectional view of a multi-rotor aircraft including a propulsion system embodying a first aspect of the invention;

FIG. 2 is a side view of the multi-rotor aircraft;

FIG. 3 is a top plan view of the multi-rotor aircraft;

FIG. 4 is a schematic diagram of the propulsion system embodying the first aspect of the invention;

FIG. 5 is a flow diagram of a method of controlling a propulsion system embodying a second aspect of the invention;

FIG. 6 is a diagram showing the operation of the power prediction system; and

FIG. 7 is a flowchart illustrating the method for controlling a propulsion system in accordance with the second aspect of the invention.

### DETAILED DESCRIPTION

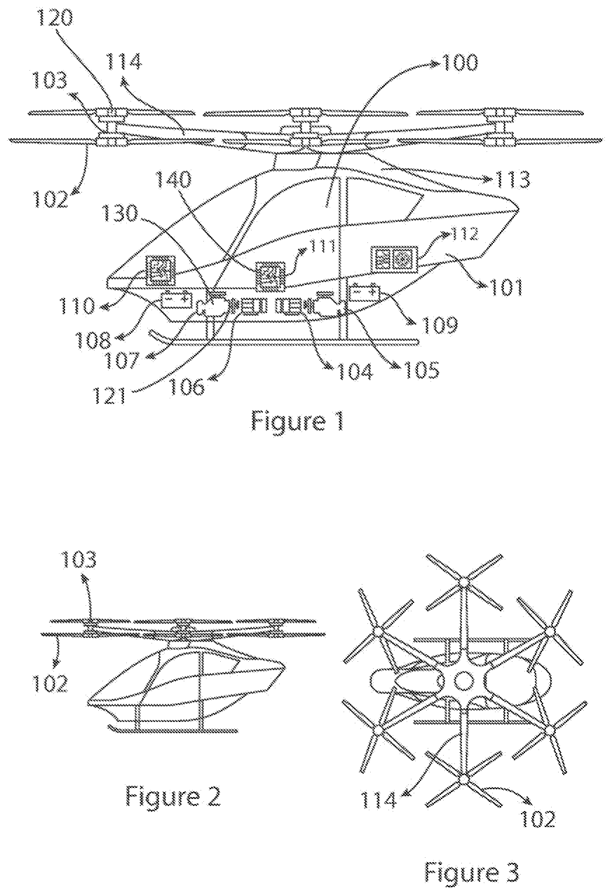

Referring now to FIG. 1 of the drawings there is shown, generally indicated as 100 a multirotor aircraft. The multirotor aircraft 100 includes a propulsion system 130 embodying a first aspect of the invention. The aircraft comprises a fuselage 101, the propulsion system 130 which comprises one or more propulsion assemblies 120 for providing thrust to the multirotor aircraft 100. The propulsion assemblies 120 are typically coupled to the multirotor aircraft through a plurality of arms 114. Preferably the multirotor aircraft 100 comprises a plurality of propulsion assemblies 120. In a preferred embodiment, as shown in FIGS. 1 to 3, the multirotor aircraft comprises six arms 114 with each arm comprising two propulsion assemblies 120, this can be seen further in FIGS. 2 and 3. However it should be understood that in alternative embodiments (not shown) each arm 114 may include only one propulsion assembly 120 or more than two propulsion assemblies 120 and if further arms 114 are provided on the multirotor aircraft 100 that additional propulsion assemblies 120 may be included therein or mounted thereon. Each propulsion assembly 120 comprises an electric motor 103 and a propeller 102 wherein the electric motor is configured to provide rotational movement to the propeller 102 such as to provide thrust to the multirotor vehicle 100.

The propulsion system 130 further comprises at least one power generation module 121 which is configured to provide a first source of electrical power to at least the one or more propulsion assemblies 120. The power generation module 121 comprises at least one internal combustion (IC) engine 105 which is mechanically connected to an electric generator 104. In a preferred embodiment, as shown in FIG. 1, the propulsion system comprises two IC engines 105, 107 which are each mechanically connected to respective electrical generators 104, 106. The IC engines 105, 107 are configured to transform the chemical energy from fuel contained within a fuel tank 112 of the multirotor aircraft 100 into mechanical energy which is then transmitted to the electrical generators 104 which transform it into electrical energy. The resulting electrical energy is used to provide power to at least the propulsion assemblies 120.

The propulsion system 130 additionally comprises a control system 140 which is configured to monitor the required electrical power demand of the propulsion assembly 120 and calculate a predicted electrical power demand for a following set period of time. Wherein the required electrical power demand should be understood as the amount of electrical power sufficient to ensure propulsion and maintain the stability of the multirotor aircraft 100 in-use. The control system 140 is configured to alter the electrical power produced by the power generation module 121, based at least upon the predicted electrical power demand, such that the power generation module 121 is configured to generate a power envelope. The power envelope should be understood to comprise a value of available electrical power, which is generated by the power generation module 121, which corresponds to the predicted electrical power demand as calculated by the control system 140. Wherein the power envelope comprises at least the predicted electrical power required to drive the propulsion assemblies 120; however it may also include excess power for providing electrical power to one or more other components of the propulsion system 130. The control system 140 typically comprises multiple controller arrangements which are configured to monitor and/or control the operations of the various components of the propulsion system 130. The control system 140 comprises a flight controller 110 which is configured to monitor and/or control the operation of the propulsion assemblies, wherein the flight controller 110 is configured to determine the electrical energy required by the propulsion assemblies 120 to achieve a specific thrust. The control system 140 further comprises a central processing unit 111 which is operable to receive information from one or more other controllers of the system such as the flight controller 110.

The control system 140 is configured to determine if the power envelope meets the required electrical power demand, wherein it should be understood that this required electrical power demand is an updated required electrical power demand which has been determined following the generation of the power envelope i.e. after a period of time has passed since the previous determination of the required power envelope. When the power envelope produced by the power generation module 121, which corresponds at least to the predicted electrical power demand previously calculated, is less than the required electrical power demand required by the propulsion system 130 to ensure sufficient operation of the one or more propulsion assemblies 120, the control system 140 is configured to selectively connect a second source of electrical power 108 for supplying power to the propulsion assembly 120 such as to compensate for the difference between the power envelope and the actual required electrical power demand. The secondary source of electrical power 108 preferably comprises one or more electrical accumulators 108, in a preferred embodiment the propulsion system comprises a plurality of electrical accumulators 108, for example, as is shown in FIG. 1, the propulsion system 130 preferably comprises at least two electrical accumulators 108, 109. The electrical accumulators 108, 109 are configured to provide additional electrical power to at least the propulsion assemblies 120 only when required such as when insufficient power is generated from the power generation module(s) 121 as may be the case where power envelope produced according to the predicted electrical power demand is less than the required electrical power demand, wherein the secondary source of electrical power 108 may be selectively connected such as to supply the propulsion system 130 with additional electrical power until the energy deficiency can be overcome by additional electrical power being produced by the power generation module(s) 121 or when the power generation module(s) 121 suffer a malfunction or the like. For example in the event of a failure of the power generation module(s) 121 the secondary source of electrical power may be used to ensure the multirotor aircraft 100 has sufficient time to land safely. It is preferred that the power generation module(s) 121 primarily supply electrical power to the propulsion system with the electrical accumulators 108 providing a backup power supply for added redundancy. When not in use, i.e. not providing electrical power to the propulsion system, the secondary source of electrical power 108 may be charged by the electrical energy produced by the power generation module(s) 121, for example the power envelope, produced corresponding to the predicted electrical power demand, may include not only the power required to supply power to the one or more propulsion assemblies 120 for their safe operation but also additional power for charging the electrical accumulators 107, 109 when required. Preferably the electrical accumulators 107, 109 comprise one or more batteries or battery arrays or the like. In a preferred embodiment the electrical accumulators comprise one or more Li-Po electrical accumulator assemblies.

When the power envelope produced by the power generation module 121 corresponding to the predicted electrical power demand exceeds the required electrical power demand, the control system is configured to selectively connect an electrical load assembly 112 such as to compensate for the difference between the predicated electrical power demand and the required electrical power demand. The electrical load assembly 112 may comprise various auxiliary aircraft components such as but not limited to air conditioning system, heating systems, lights, display devices, computing devices etc., as well as passive loads such as electric resistors or the like. Advantageously, the electrical load assembly 112 is therefore an adaptive energy balancing instrument of the system, wherein one or more loads can be selectively connected and disconnected to or from the propulsion system as and when required.

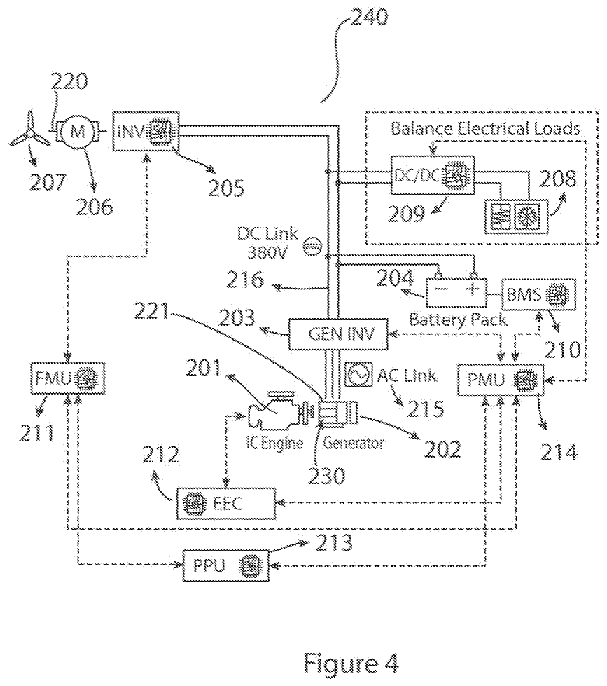

Referring now to FIG. 4, this shows a schematic diagram of the propulsion system which is generally indicated by the reference numeral 230. The control system 240 comprises a plurality of controllers which can be seen in FIG. 4. To this end the control system 240 comprises the central processing unit 214 which is coupled to and operable to receive information from one or more other controllers of the control system and transmit instructions to the one or more controllers based on said information, such as to selectively connect the secondary power source 204 or the electrical load assembly 208 as described previously. The central processing unit 214 comprises any suitable processing or computing device. The control system 240 comprises the flight controller 211 which, as mentioned previously, is configured to monitor and/or control the operation of the propulsion assemblies 220, wherein the flight controller 211 is configured to determine the electrical energy required by the propulsion assemblies 220 to achieve a specific thrust. To determine the electrical energy required by the propulsion assemblies 220 the flight controller 211 may further comprise one or more sensors or any other suitable means configured to measure one or more environmental conditions regarding the environment in which the aircraft 100 is located wherein the environmental conditions may comprise one or more of temperature, humidity, wind speed, air density, wind direction, atmospheric turbulence intensity etc. The flight controller 211 is configured to control the thrust generated by each propulsion assembly 220 so as to ensure the flight stability of the multirotor aircraft, as well as for executing the flight mission including flight maneuvers such as automatically following a flight plan or executing climb/descent maneuvers, rolling, approaching, takeoff, landing, compensating for atmospheric turbulence, wind, etc. The flight controller 211 is communicatively coupled to the central processing unit 214 and is operable to provide the central processing unit 214 with the currently required power demand to power at least the propulsion assemblies 220.

The control system 240 further ideally comprises a power prediction unit 213 which is configured to calculate the predicted electrical power demand for a set period of time. The power prediction unit 213 is configured to continuously calculate the predicted electrical power demand to ensure efficient performance of the propulsion system. To this end, the power prediction unit 213 Is communicatively coupled to the flight controller 211 and is operable to calculate the predicted electrical power demand based at least upon data obtained from the flight controller 211, wherein such data may include at least one of: the required energy in the last “n” time samples; stage and type of current flight (vertical take-off, hovering, cruise flight, final approach, fixed-point landing, etc.); environment data (temperature, air density and humidity); data regarding wind intensity and direction, as well as the atmospheric turbulence intensity; flight configuration (weight at takeoff, quantity of fuel consumed since takeoff, center of gravity position relative to centre of pressure); and/or predictable flight commands according to flight plan (acceleration, deceleration, changing flight altitude). The power prediction unit 213 is further communicatively coupled to the central processing unit 214 and is operable to provide the central processing unit 214 with the predicted power demand of the propulsion system. Based on this information, the power prediction unit 213 is operable to calculate the probable range of variation in the electrical energy used by the aircraft 100 for propulsion. Furthermore, this will minimize the difference between the power envelope produced corresponding to the predicted electrical power demand and the required electrical power demand, in order to decrease fuel consumption. As a result of this, an operating condition for the internal combustion engine 201 can be determined where: the power setting will be changed as rarely as possible which advantageously means that the energy efficiency is maximized, due to the fact that the operation of the engine covers the required electrical power demand as closely as possible with reduced variation in the operating conditions of the internal combustion engine 201.

The control system 240 further preferably comprises an engine controller 212 which is configured to monitor and/or control the operation of the internal combustion engine 201, wherein the engine controller 212 is configured to monitor and/or control one or more operating conditions of the internal combustion engine 201 which may include one or more of: increasing or decreasing generated mechanical power, maintaining a specific rotational speed, adjusting the air to fuel ratio, monitoring the temperature or pressure of the internal combustion engine 201. The engine controller 212 is coupled to the internal combustion engine 201 and also to the central processing unit 214 such that the engine controller 201 is operable to control the operation of the internal combustion engine 201 according to instructions received from the central processing until 214 such as to increase or decrease produced mechanical power produced therefrom in accordance with the predicted and/or current electrical power demand.

The control system 240 further typically comprises a generator controller 203 which is configured to, convert the AC current produced by the electrical generator 202 into DC, and/or control the operation of the electrical generator 202 wherein the generator controller 203 is operable to, initiate the generator, controlling generated voltage—inverter function, disconnect the generator in the event of a malfunction or monitor temperature to prevent overheating. To this end the generator controller 203 is communicatively coupled to the electrical generator 202 and also to the central processing unit 214 such that generator controller 203 is operable to control the operation of the generator 202 according to instructions received from the central processing until 214. In-use the internal combustion engine 201 is typically operable to generate AC for supply to the generator 202, which typically comprises a three-phase electric generator unit. The electrical output from the generator 202 is typically rectified and controlled by the generator controller 203, which ideally comprises an inverter or the like, wherein the power output therefrom is transported, typically through a DC Link 216 connection to the propulsion assembly 220. The electric motor 206 of the propulsion assembly 220 is typically controlled through a direct current—three-phase current inverter 205 which ensures the supply of the propulsion power demanded by the flight controller 211. The electrical accumulator 204 and/or the electrical load assembly 208 may also be electrically coupled to the DC link 216.

The control system 240 typically additionally comprises an electrical accumulator controller 210 for monitoring and/or controlling the operation of the electrical accumulator, wherein said monitoring typically includes one or more of determining the health of the accumulator, determining the status of individual cells of the accumulator and/or determining the current level of charge. The electrical accumulator controller 210 is further communicatively coupled to the electrical accumulator 204 and to the central processing unit 214 such that in instances were the power envelope produced by the power generation module corresponding to the predicted electrical power demand is less than the required electrical power demand the electrical accumulator controller 210 is operable to selectively connect the electrical accumulator 204 to provide additional electrical power such as to compensate for the difference between the power envelope and the required electrical power demand in response to instructions received from the central processing unit 214.

The control system 240 preferably further comprises a load control unit 209 configured to selectively connect the one or more electrical load assemblies 208 in response to instructions received from the central processing unit 214 such as when the power envelope produced by the power generation module 221 corresponding to the predicted electrical power demand exceeds the required electrical power demand the control system such as to compensate for the difference between the predicated electrical power demand and the required electrical power demand. The electrical load assemblies are typically coupled to the propulsion system by the load control unit 209 as can be seen in FIG. 4.

The predicted electrical power demand calculated by the power prediction unit 213 represents a level of energy, produced in surplus by the power generation module, which is sufficient to supply the energy requirements of the multirotor aircraft in the short term, so that the electrical accumulators 204 is used as rarely as possible. Through this mechanism a sufficient power reserve is maintained and available at all times, in order to supply the power demand required by variations in the conditions/flight mission.

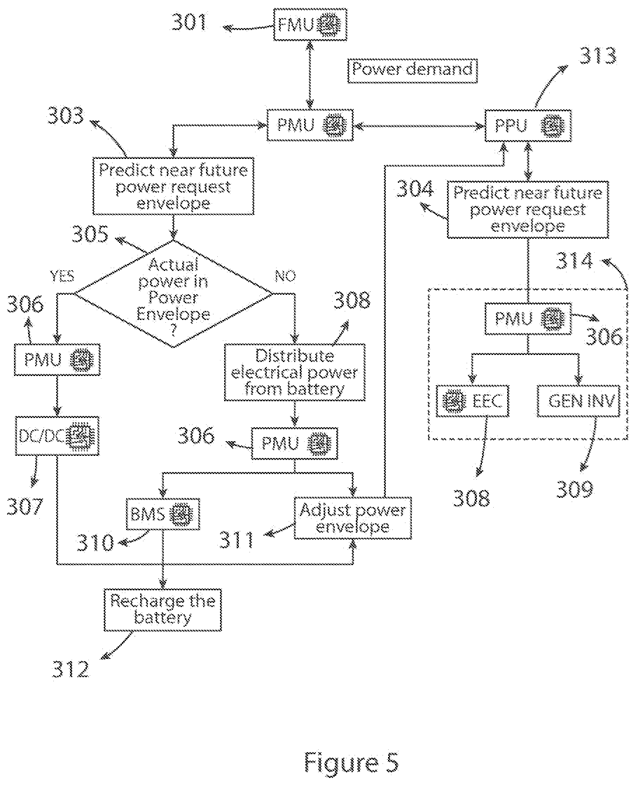

Referring now to FIG. 5 this shows a flow diagram illustrating a method of controlling the propulsion system for multirotor aircraft in accordance with a second aspect of the invention which is generally indicated by the reference numeral 300. The method advantageously ensures the supply of electrical energy required by the propulsion system at optimum efficiency conditions. The flight controller 301 is configured to transmit data indicative of the required electrical power demand to the central processing unit 306. Following this the central processing unit 306 is configured to determine if the power envelope generated corresponding to the predicted electrical power demand is sufficient to meet the required electrical power demand 305 of the propulsion system. If yes, the power envelope exceeds the required electrical power demand the central processing unit 306 is configured to selectively connect one or more of the electrical load assemblies 208, typically via the DC link 307, wherein by selectively connecting the one or more electrical load assemblies 208 the electrical energy consumption of the propulsion system can be effectively balanced whilst ensuring that sufficient power is available in the system for propulsion.

Following this, typically after a predetermined amount of time or following an amount of time dependent upon one or more measurements obtained by the flight controller 301, the power prediction unit 313 is configured to determine if the predicted electrical power demand and corresponding power envelope is still accurate, i.e. sufficient to meet the required electrical power demand based on new flight conditions received from the flight controller 303, at this time a decision is made, whether to modify the size of the predicted electrical power demand or not, by increasing or decreasing it 311. If the power envelope produced corresponding to the predicted electrical power demand is less than the required electrical the central processing unit 306 is configured to selectively connect the electrical accumulator 204 at step 308 to compensate for the difference between the power envelope corresponding to the predicted electrical power demand and the required electrical power demand. Following this the central processing unit 306 is configured to communicate with the power prediction unit 313 to adjust the predicted electrical power demand 304 such that the power envelope produced according to the predicted electrical power demand meets the required electrical power demand.

Once the predicted electrical power demand has been adjusted the power prediction unit 313 is configured to communicate the new operating conditions 314 to the Engine controller 308 and generator controller 309 such as to affect alteration of the operating conditions of the internal combustion engine 201 and electrical generator 202 respectively such as to generate the power envelope corresponding to the update predicted electrical power demand. Preferably after the predicted electrical power demand has been adjusted, the electrical accumulators 204 is disconnected from the system and the electrical accumulator 204 is instructed to enter, by the electrical accumulator controller 310, a state of charge and rebalancing 312 wherein the electrical accumulator 204 is charged by the electrical power provided by the power generation module 221, typically until it reaches a charge level of approximately 85-90% (state of charge).

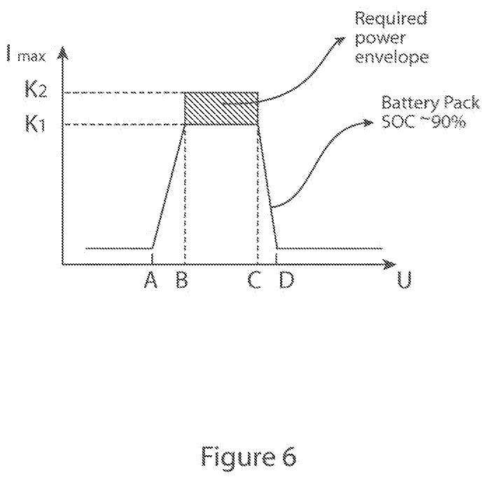

Referring now to FIG. 6 there is shown a schematic diagram illustrating the strategy for controlling the power generated by the power generation module 121 comprising the internal combustion engine 201 and the electrical generator 202 as described previously and the electrical accumulators 204. The generator controller 203 is configured to provide voltage control and available power control in the system by providing the DC Link portion with direct current as shown in FIG. 4. The power generated by the IC Engine 201, Generator 202, and generator controller 203 is controlled in order to maintain a state of charge (SOC) of ideally 85-90% in the accumulator 204, or the range shown between points C and D (FIG. 6). Furthermore, by selectively connecting the load assembly 208 through the load control unit 209 to the DC Link electrical power bus, the system advantageously ensures that the electrical power produced corresponds to the predicted power envelope for balancing. This is handled, at least in part, by the engine controller unit 212 which is configured to control the operation of the internal combustion engine 201 and therefore the generated mechanical power, ensuring a level of available electric current K2 corresponding to the predicted electrical power demand is greater than the required electrical power demand K1.

The power envelope corresponding to the predicted electrical power demand is calculated by the power prediction unit 213, which predictively evaluates, based on a fuzzy adaptive algorithm, the level of electrical energy required at least for the propulsion of the multirotor aircraft. Wherein the fuzzy adaptive algorithm comprises, a method for predicting the predicted electrical power demand of the propulsion system, which comprises one or more of the following steps:

Measuring the required electrical energy demand in the last “n” time samples;
Measuring the stage and type of the current flight, for example the stage of the current flight may include take-off, hovering, final approach, landing and wherein the type of flight may include cruise fight etc.;
Measuring, the environment data, preferably wherein measuring the environment data may comprise measuring the current environment, ideally said measurement data may include the temperature, air density, humidity, wind intensity, wind direction, and/or the atmospheric turbulence intensity of the current environment;
Measuring one or more flight configuration, wherein said flight configurations may include: weight at take-off, quantity of fuel consumed since take-off, centre of gravity position relative to centre of pressure, and/or predictable flight commands according to flight plan (acceleration, deceleration, changing flight altitude); and
Calculating a predicted electrical power demand using one or more of the measurements obtained at any one of the steps of a) to d);
Transmitting the predicted electrical power demand.

Optionally, g) repeating steps a) to f) at predetermined time intervals.

The above steps are typically performed by the power prediction unit 313 which is coupled to the flight controller 301 and the central processing unit 301, at least. Wherein the power prediction unit 313 is operable to receive the various measurements obtained in the steps a) to d) recited above calculate the predicted electrical power demand and transmit this to the central processing unit 301.

The fuzzy adaptive algorithm provides the following advantages:
Predicting the level of electrical energy required to run the aircraft's 100 propulsion for the following short time period.
Permanently maintaining a state of charge of 85-90% in the accumulators 204 (conditions which maximize their lifespan and ensure the existence of an electrical energy reserve at all times, which is sufficient to run the aircraft's 100 propulsion in case of malfunction of the power generator module 221, and allows for an emergency landing)
Maintaining the internal combustion engines 201 at a constant speed (RPM) and modifying the RPM as rarely as possible—advantageously this ensures the lowest fuel consumption.
Maintaining the level of electrical energy generated by the power generation module 221 at a level which is as close as possible to the necessary level for ensuring the propulsion of the multirotor aircraft 100.
The adaptive calculation of the predicted electrical power demand which ensures that the energy stored in the accumulators 204 is used as rarely as possible (this decreases the installed power of the accumulator 204 and its weight and also maximizes the lifespan of the accumulator 204 by reducing the number of charge/discharge cycles)
Reducing the level of the predicted electrical power demand with respect to the required electrical power demand (i.e. the difference between generated current K2 and required current K1) in order to increases energy efficiency.

The existence of the predicted electrical power demand and the corresponding power envelope ensures that the mechanical power generated by the internal combustion engine 201 is varied as rarely as possible, since the propulsion system provides that operation of the internal combustion engine 201 is typically at a substantially constant speed and power which provides the greatest energy efficiency. It is known that operating an internal combustion engine at a constant speed and within the maximum efficiency limits increases its efficiency by 50% (see “Improving IC Engine Efficiency”. University of Washington: Energy & Environment—Autumn 2001.) Furthermore, efficiently maintaining the power envelope corresponding to the predicted electrical power demand in the system leads to a decreased use of the accumulator 204 under constant operating conditions, which extends the life of the accumulator 204, due to the very low number of charge cycles, and also can reduce the required installed electric power of the electrical accumulators by 35%, which implies a decrease of over 35% in the mass of the accumulators 204. With weight loss being a key advantage for aircraft enabling greater flight range and/or allowing for additionally auxiliary loads.

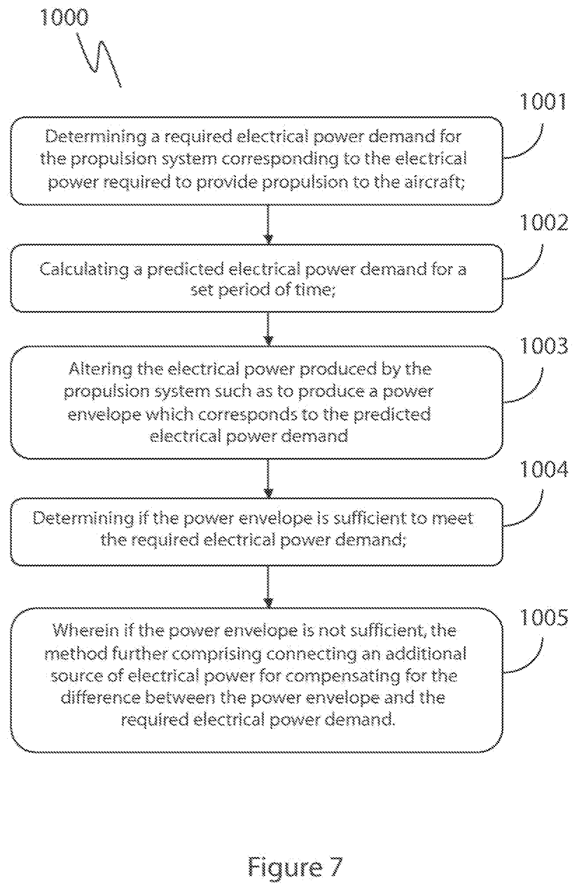

FIG. 7 is shows a flow diagram further illustrating the method of controlling the propulsion system for multirotor aircraft in accordance with the second aspect of the invention which is generally indicated by the reference numeral 1000. The method comprises the steps of: Determining a required electrical power demand for the propulsion system corresponding to the electrical power required to provide propulsion to the aircraft 1001; Calculating a predicted electrical power demand for a set period of time 1002; Altering the electrical power produced by the propulsion system such as to produce a power envelope which corresponds to the predicted electrical power demand 1003; Determining if the power envelope is sufficient to meet the required electrical power demand 1004; Wherein if the power envelope is not sufficient, the method further comprising connecting an additional source of electrical power for compensating for the difference between the power envelope and the required electrical power demand 1005.

Advantageously, the propulsion system of the present invention provides a hybrid electric propulsion system capable of supplying the required propulsion energy of a multirotor aircraft 100 for significant time periods: 3 to 4 hours (comparable to traditional aircraft). Furthermore the propulsion system is a much more reliable propulsion system than those currently available, due to the existence of a plurality of redundancies (due to the existence of multiple power generation modules 221 comprising the motor-generator units, the existence of an electrical accumulator 204 which can supply, by itself and at any time, the entire power demand required for the aircraft's propulsion, partially or fully. Further the system provides a closed loop control system which continuously evaluates the health state of all its components, is capable of reconfiguring itself in the event of a malfunction of one or more components, ensuring that the quantity of supplied electrical energy is always sufficient for the aircraft's propulsion.

The predictive and adaptive algorithm provided herein insures both the operation of the various components of the system at maximum efficiency, and allows for a reduction of the weight by requiring fewer electrical accumulators. This means that the payload capacity is increased, while the fuel consumption decreases due to the smaller mass of the aircraft. The propulsion system provided by the current invention provides the possibility of implementing a distributed electric propulsion system (DEP) in commercial aviation, which has major advantages when compared to traditional rotary-wing aircraft (helicopters, gyrocopters, etc.), including: redundancy—depending on the number of rotors employed, the aircraft can remain stable in flight after the failure of one or more rotors—unlike helicopters, for example, where a major malfunction on the main or tail rotors often results in aviation disasters; and a significant reduction of weight, due to the absence of mechanical transmission assemblies (gear boxes, transmission axles, mechanical couplings, etc.) and the lack of complex control mechanisms (for example: the cyclic variable pitch in helicopters)—this leads to increased reliability, a decrease in required maintenance, etc.

It will be understood that while exemplary features of a propulsion system for a multi-rotor aircraft have been described, that such an arrangement is not to be construed as limiting the invention to such features. The method for controlling a propulsion system for a multi-rotor aircraft may be implemented in software, firmware, hardware, or a combination thereof. In one mode, the method is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the method for controlling a propulsion system for a multi-rotor aircraft. The processor(s) is a hardware device for executing software, particularly software stored in memory. Processor(s) can be any custom made or commercially available processor, a primary processing unit (CPU), an auxiliary processor among several processors associated with a computer, a semiconductor based microprocessor (in the form of a microchip or chip set), a macro-processor, or generally any device for executing software instructions.

Memory is associated with processor(s) and can include any one or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present disclosure may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this disclosure, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the process, as would be understood by those having ordinary skill in the art.

The above detailed description of embodiments of the disclosure is not intended to be exhaustive nor to limit the disclosure to the exact form disclosed. While specific examples for the disclosure are described above for illustrative purposes, those skilled in the relevant art will recognize various modifications are possible within the scope of the disclosure. For example, while processes and blocks have been demonstrated in a particular order, different implementations may perform routines or employ systems having blocks, in an alternate order, and some processes or blocks may be deleted, supplemented, added, moved, separated, combined, and/or modified to provide different combinations or sub-combinations. Each of these processes or blocks may be implemented in a variety of alternate ways. Also, while processes or blocks are at times shown as being performed in sequence, these processes or blocks may instead be performed or implemented in parallel or may be performed at different times. The results of processes or blocks may be also held in a non-persistent store as a method of increasing throughput and reducing processing requirements.

The invention is not limited to the embodiment(s) described herein but can be amended or modified without departing from the scope of the present invention.

1. A propulsion system for a multirotor aircraft, the propulsion system comprising:
At least one power generation module configured to provide a first source of electrical power to one or more propulsion assemblies of the multirotor aircraft;
A control system which is configured to determine the required electrical power demand of the propulsion assembly and calculate a predicted electrical power demand for a following period of time;
Wherein the control system is configured to alter the electrical power produced by the power generation module such as to produce a power envelope which comprises the electrical power produced by the power generation module corresponding to the predicted electrical power demand;
Wherein the control system is configured to determine if the power envelope meets the required electrical power demand; and
Wherein when the power envelope is less than the required electrical power demand the control system is configured to selectively connect a second source of electrical power for supplying power to the propulsion assembly such as to compensate for the difference between the power envelope and the required electrical power demand.

2. The propulsion system of claim 1, wherein when the power envelope exceeds the required electrical power demand the control system is configured to selectively connect an electrical load assembly such as to compensate for the difference between the power envelope and the required electrical power demand.

3. The propulsion system of claim 1, comprising at least two power generation modules.

4. *Currently Amended) The propulsion system of claim 1, wherein the power generation module(s) comprise an internal combustion engine and an electric generator, wherein the internal combustion engine is configured to drive the electrical generator.

5. The propulsion system of claim 2, wherein the electrical load assembly comprises one or more auxiliary components such as air conditioning systems, heating systems, lights, display devices, computing devices or any other suitable device.

6. The propulsion system of claim 2, wherein the electrical load assembly comprises passive loads such as an electrical resistor.

7. The propulsion system of claim 1, wherein the second source of electrical power comprises one or more electrical accumulators such as a battery.

8. The propulsion system of claim 1 wherein the propulsion assembly comprises an electric motor coupled to a propeller.

9. The propulsion system of claim 1, further comprising a plurality of propulsion assemblies.

10. The propulsion system of claim 1, wherein the control system comprises a flight controller which is configured to monitor and/or control the operation of the propulsion assemblies, wherein the flight controller is configured to determine the electrical energy required by the propulsion assemblies to achieve a specific thrust.

11. The propulsion system of claim 10, wherein the flight controller is configured to determine the electrical energy required by the propulsion assemblies to achieve a specific thrust using measurements of one or more environmental conditions obtained by the flight controller.

12. The propulsion system of claim 11, wherein the flight controller comprises one or more sensors configured to measure the environmental conditions.

13. The propulsion system of claim 1, wherein the control system further comprises a power prediction system which is configured to determine the predicted electrical power demand.

14. The propulsion system of claim 13, wherein the power prediction system is coupled to the flight controller and is configured to determine the predicted electrical power demand using one or more measurements obtained therefrom.

15. The propulsion system of claim 14, wherein the one or more measurements comprise at least one of: the required electrical energy in the last “n” time samples; stage and type of current flight; environment data; data regarding wind intensity and direction,; atmospheric turbulence intensity; flight configuration; and/or predictable flight commands according to flight plan.

16. The propulsion system of claim 4, wherein the control system comprises an engine controller which is configured to monitor and/or control the operation of the internal combustion engine, wherein the engine controller is configured to control one or more operating conditions of the combustion engine.

17. The propulsion system of claim 4, wherein the control system comprises a generator controller configured to, convert the AC current produced by the electrical generator into DC, and/or control the operation of the electrical generator, wherein the generator controller is configured to control one or more operating conditions of the electrical generator.

18. The propulsion system of claim 7, wherein the control system comprises an electrical controller for monitoring and/or controlling the operation of the electrical accumulator.

19. The propulsion system of claim 2, wherein the control system comprises a load control unit configured to selectively connect the one or more electrical loads.

20. The propulsion system of claim 10, wherein the control system comprises a central processing unit to which the flight controller and/or power predication system and/or engine controller and/or generator controller and/or load control unit are coupled to and configured to receive instructions therefrom.

21. A multirotor aircraft comprising the propulsion system as claim in claim 1.

22. A method for controlling a propulsion system for a multirotor aircraft, the method comprising:
a. Determining a required electrical power demand for the propulsion system corresponding to the electrical power required to provide propulsion to the aircraft;
b. Calculating a predicted electrical power demand for a set period of time;
c. Altering the electrical power produced by the propulsion system such as to produce a power envelope which corresponds to the predicted electrical power demand;
d. Determining if the power envelope is sufficient to meet the required electrical power demand;
e. Wherein if the power envelope is not sufficient, the method further comprising connecting an additional source of electrical power for compensating for the difference between the power envelope and the required electrical power demand.

23. The method of claim 22, further comprising: f. wherein if the power envelope is sufficient, the method further comprising connecting an electrical load assembly.

24. The method of claim 22, further comprising: g. repeating steps a. to d. at pre-set time intervals.

25. The method of claim 22, wherein calculating the predicted electrical power demand comprises one or more of the following steps:
a) Measuring the required electrical energy demand in the last “n” time samples;
b) Measuring one or more characteristics of the current flight;
c) Measuring environment data of the environment in which the aircraft is located;
d) Measuring one or more flight configurations; and
e) Calculating a predicted electrical power demand using one or more of the measurements obtained at any one of the steps of a) to d).

26. A computer-readable medium comprising non-transitory instructions which, when executed, cause a processor to carry out a method according to claim 22.
